(19) United States
(12) Patent Application Publication
(10) Pub. No.: US 2007/0137093 A1
(43) Pub. Date: Jun. 21, 2007

(54) Decoy technology

(76) Inventor: Douglas L. Crain, Hudson, WI (US)

Correspondence Address: JOEL D. SKINNER, JR.;SKINNER AND ASSOCIATES, 212 COMMERCIAL ST., HUDSON, WI, 54016, US

(21) Appl. No.: 11/495,024

(22) Filed: Jul. 28, 2006

Related U.S. Application Data
(60) Provisional application No. 60/704,221, filed on Aug. 1, 2005.

(51) Int. Cl. A01M 31/06

(52) U.S. Cl. 43/3

(57) ABSTRACT

A decoy including a body, a stake extending from the body for connection to earth, and wings extending from the body. The wings have a first surface which has a convex or convex-like configuration. Lights, preferably LEDs are constructed and arranged relative to the first surface such that they emit light away from the first surface and to the environment. The LEDs are selectively activated so as to simulate wing movement.

### BACKGROUND OF THE INVENTION

1. Field of the Invention

The present invention relates, generally, to sporting and recreational equipment. Particularly, the invention relates to hunting and birding decoy equipment. Most particularly, the invention relates to a lighted wing bird decoy.

2. Background Information

The state of the art includes various bird decoys, including a decoy design described in U.S. Pat. No. 6,460,284, issued Oct. 8, 2002 to Rabo. This patent discloses a decoy with a buoyant body, a wing simulating structure with an upwardly dished upper surface, and LEDs positioned to illuminate the upper surface of a wing simulating structure.

Other patents of potential interest include U.S. Pat. Nos. 6,408,559, 6,508,028, and D469152

This technology is believed to have significant limitations and shortcomings.

For this and other reasons, a need exists for the present invention.

All US patents and patent applications, and all other published documents mentioned anywhere in this application are incorporated by reference in their entirety.

### BRIEF SUMMARY OF THE INVENTION

The invention provides a decoy apparatus and method which are practical, reliable, accurate and efficient, and which are believed to fulfil the need and to constitute an improvement over the background technology.

The invention provides a decoy including a body, a stake extending from the body for connection to earth, and wings extending from the body. The wings have a first surface which has a convex or convex-like configuration. Lights, preferably LEDs are constructed and arranged relative to the first surface such that they emit light away from the first surface and to the environment. The LEDs are selectively activated so as to simulate wing movement. A power source, such as a battery, and a control circuit are communicatively connected to the LEDs for activation.

The features, benefits and objects of the invention will become clear to those skilled in the art by reference to the following description, claim(s), if any, and drawings.

### BRIEF DESCRIPTION OF THE SEVERAL VIEWS OF THE DRAWING

FIGS. 1-19 illustrate embodiments of the decoy, parts thereof, and methods of the present invention.

### DETAILED DESCRIPTION

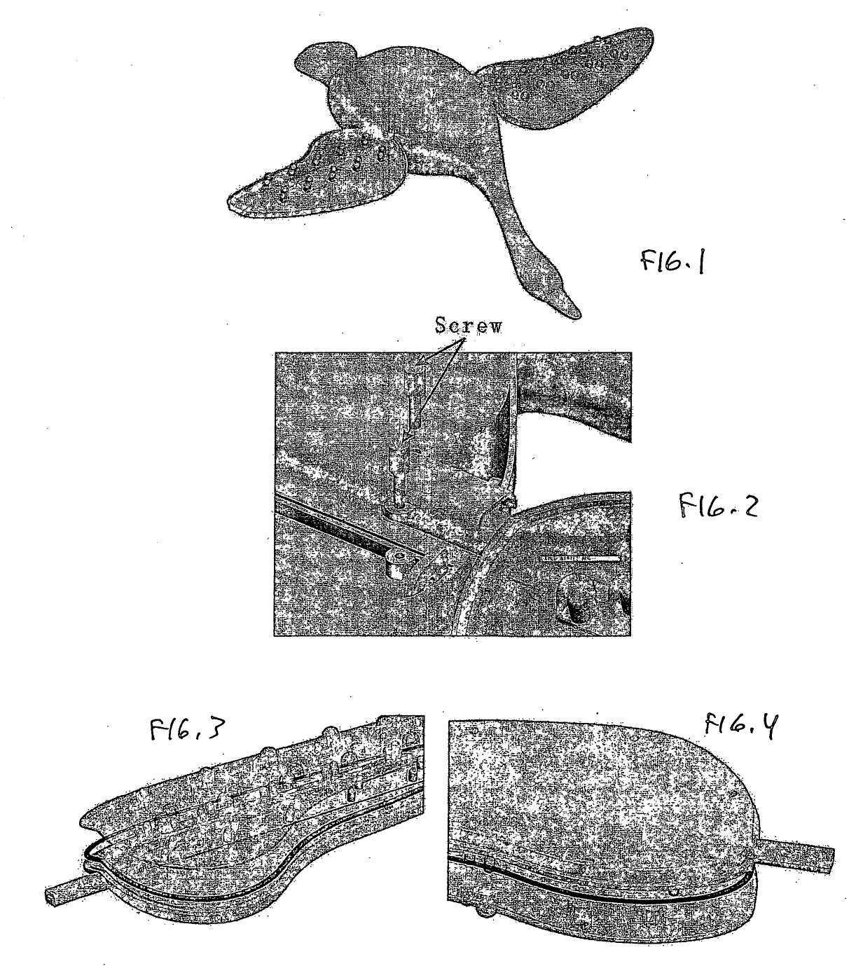

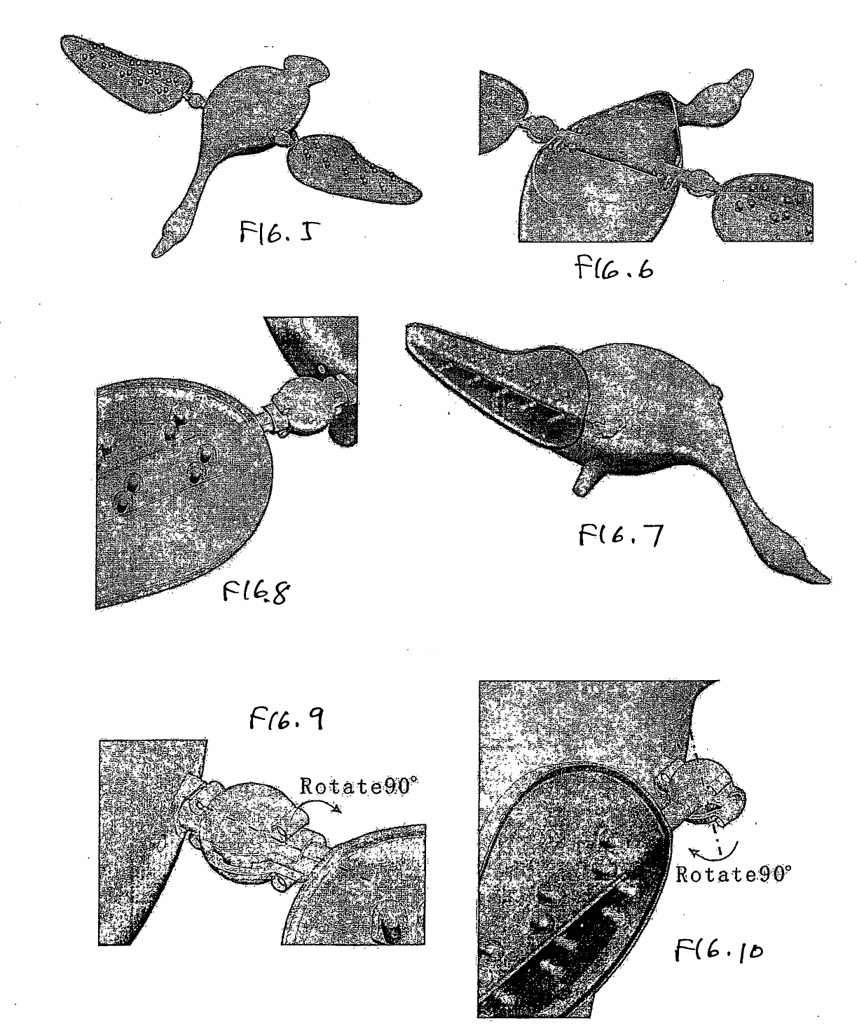

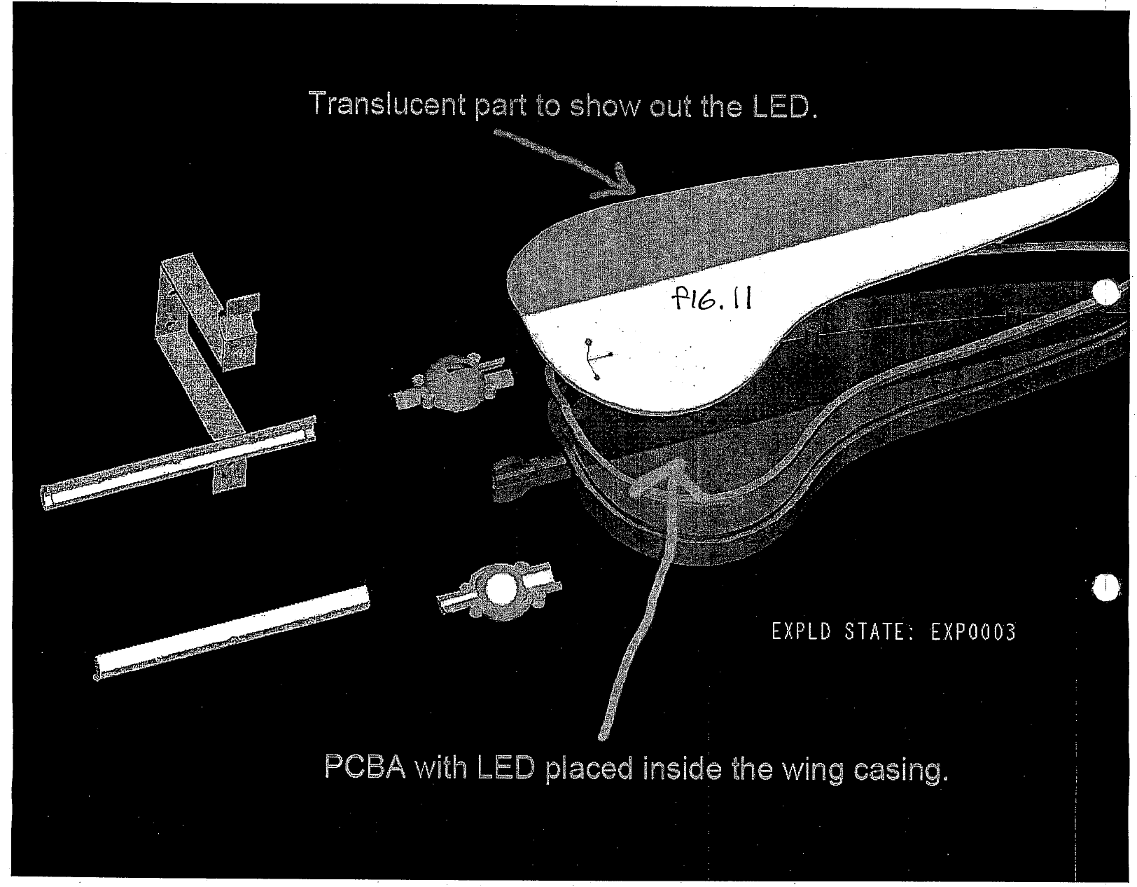

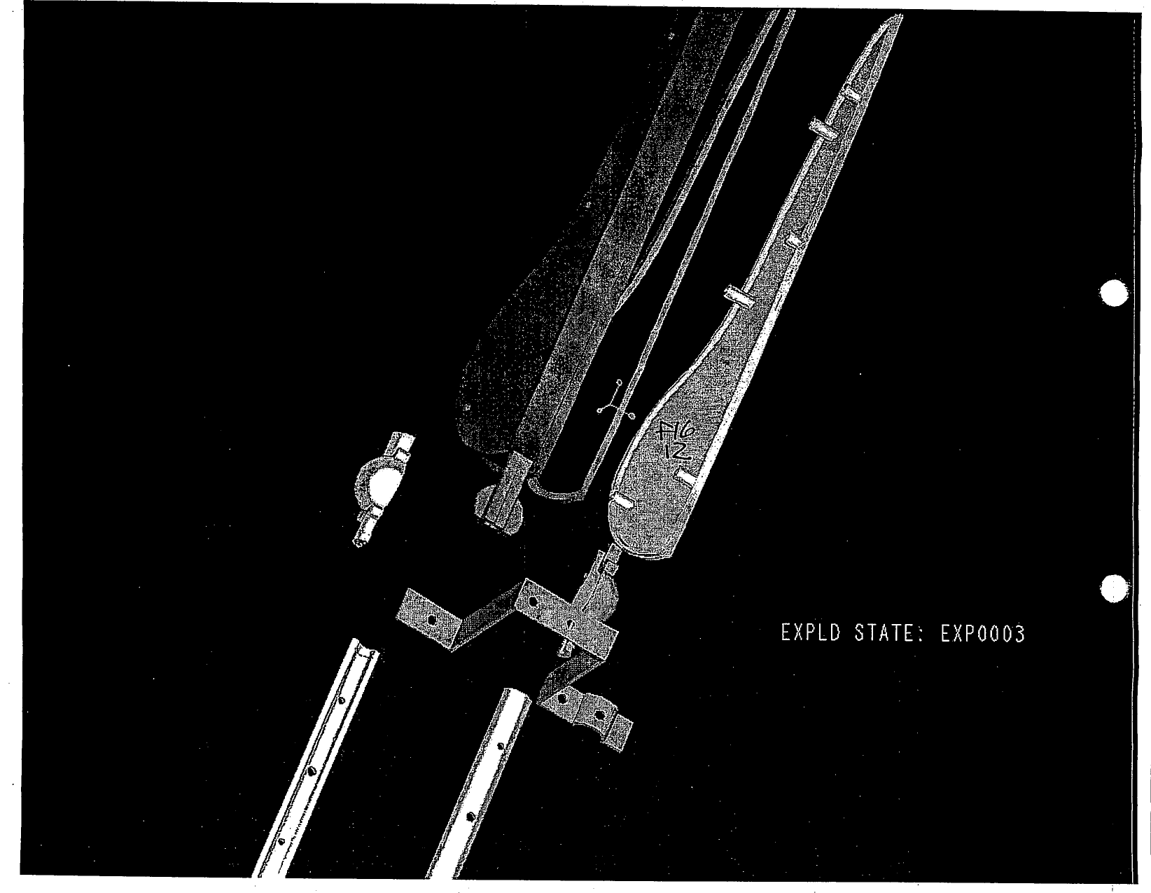

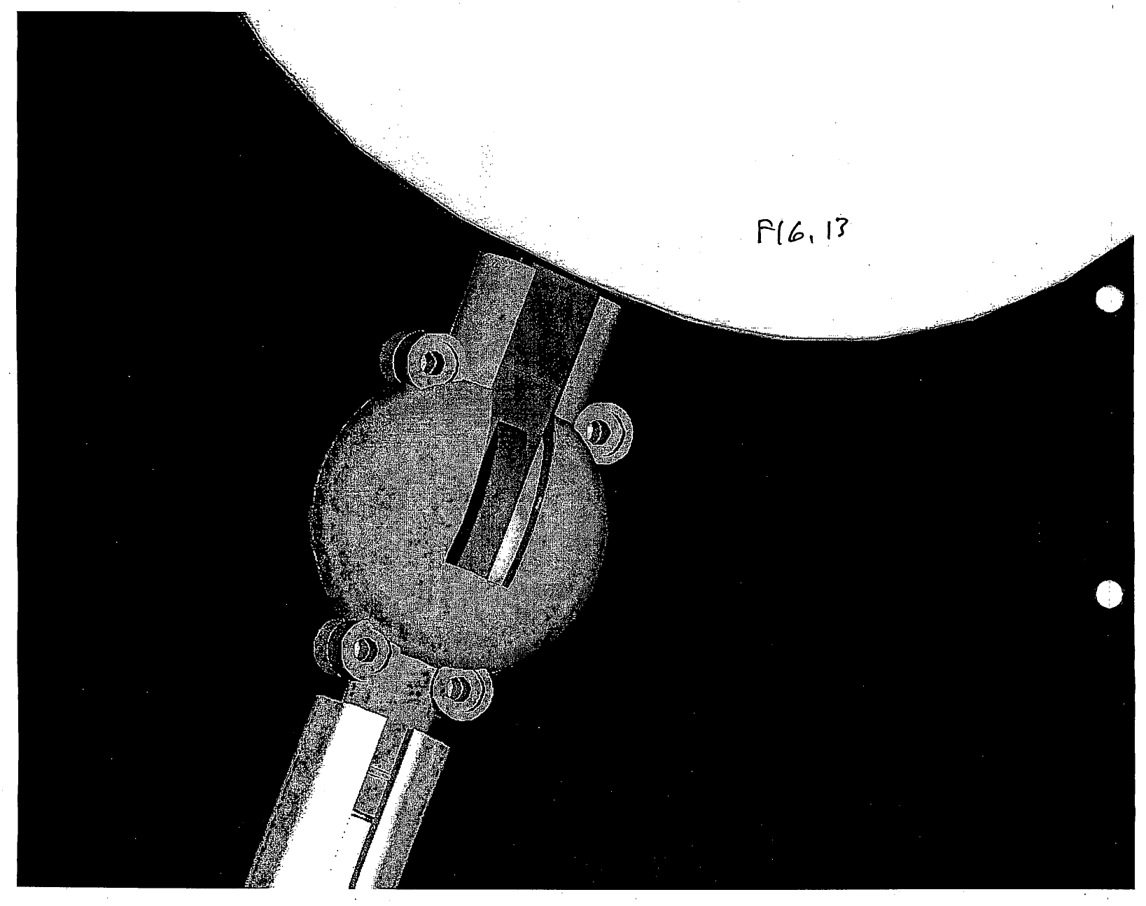

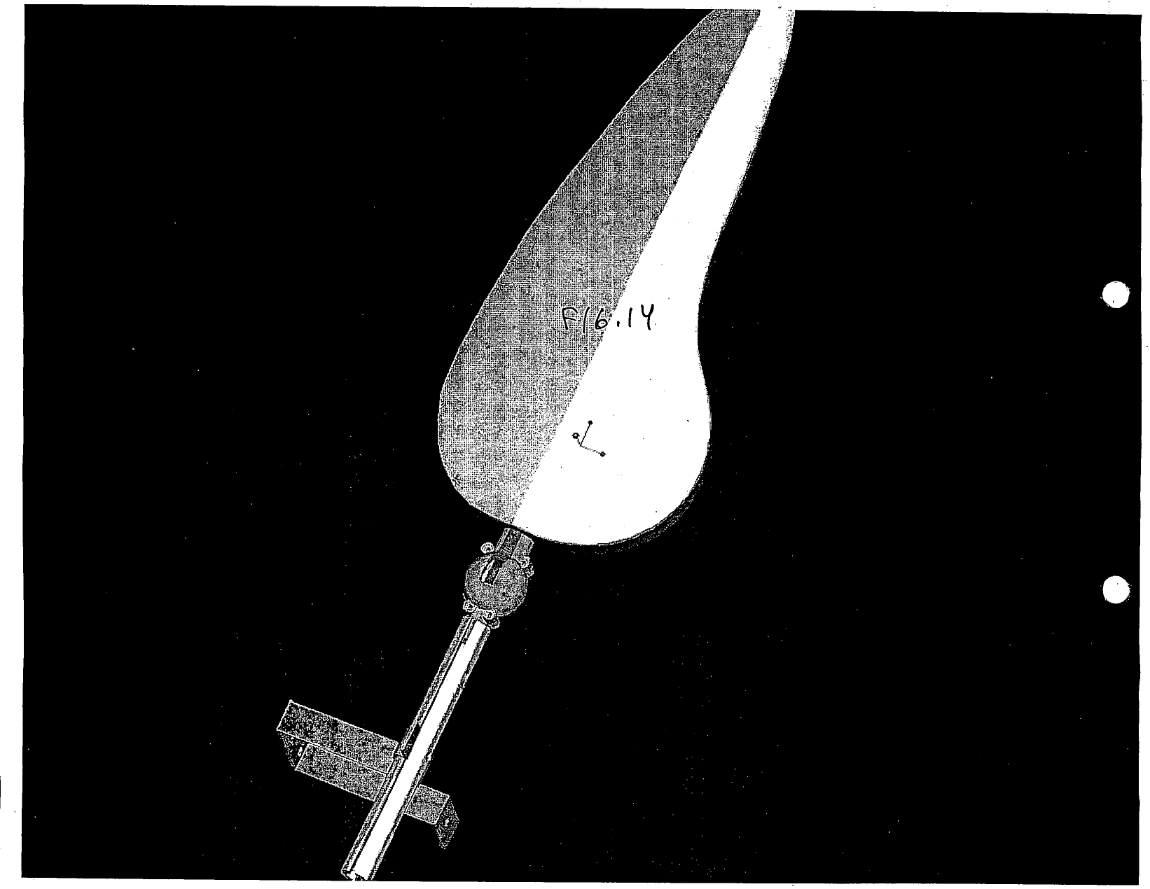

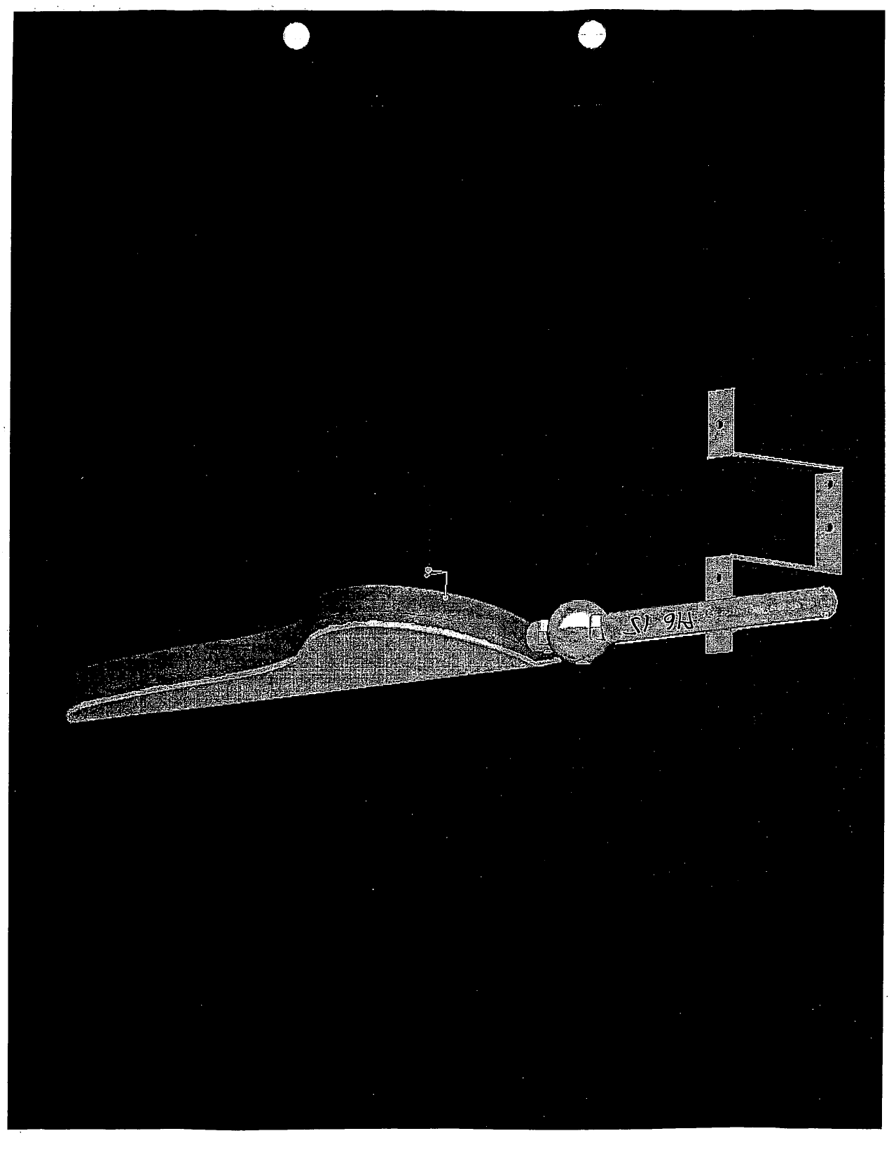

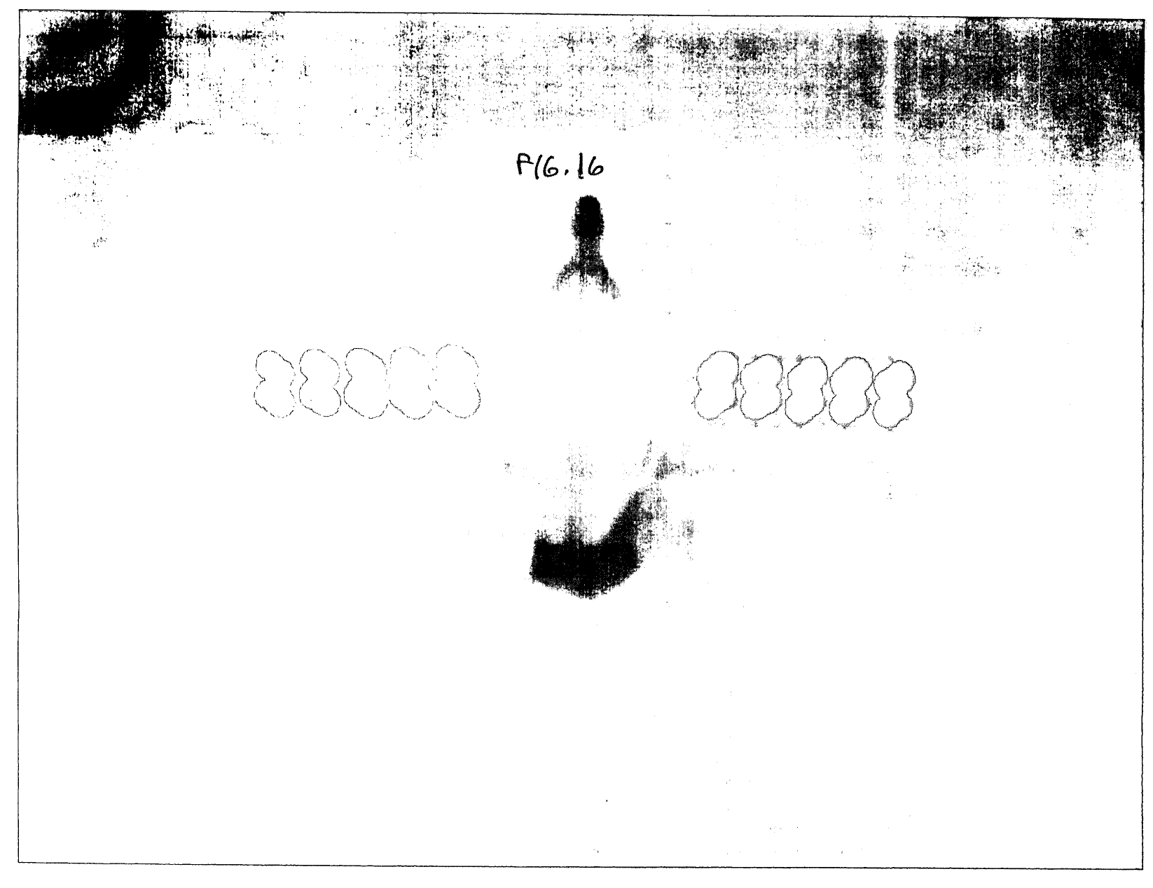

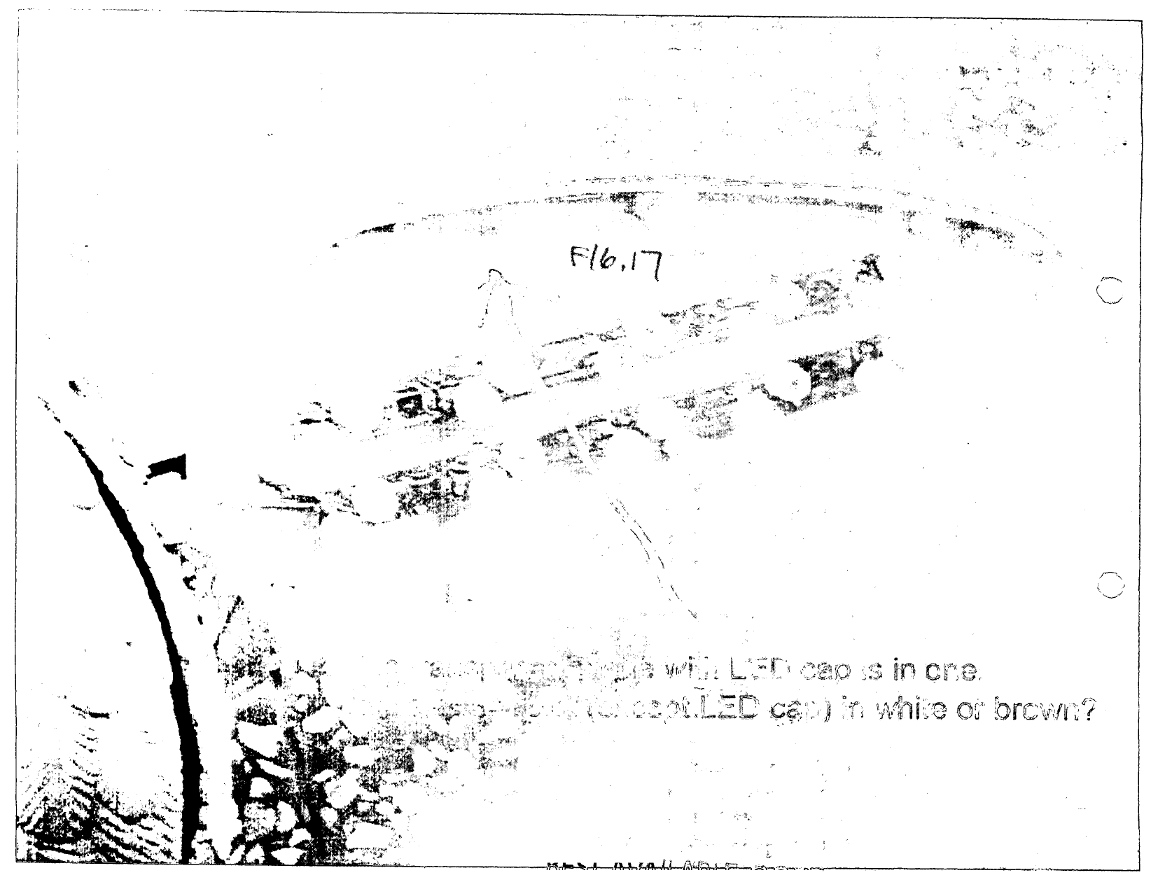

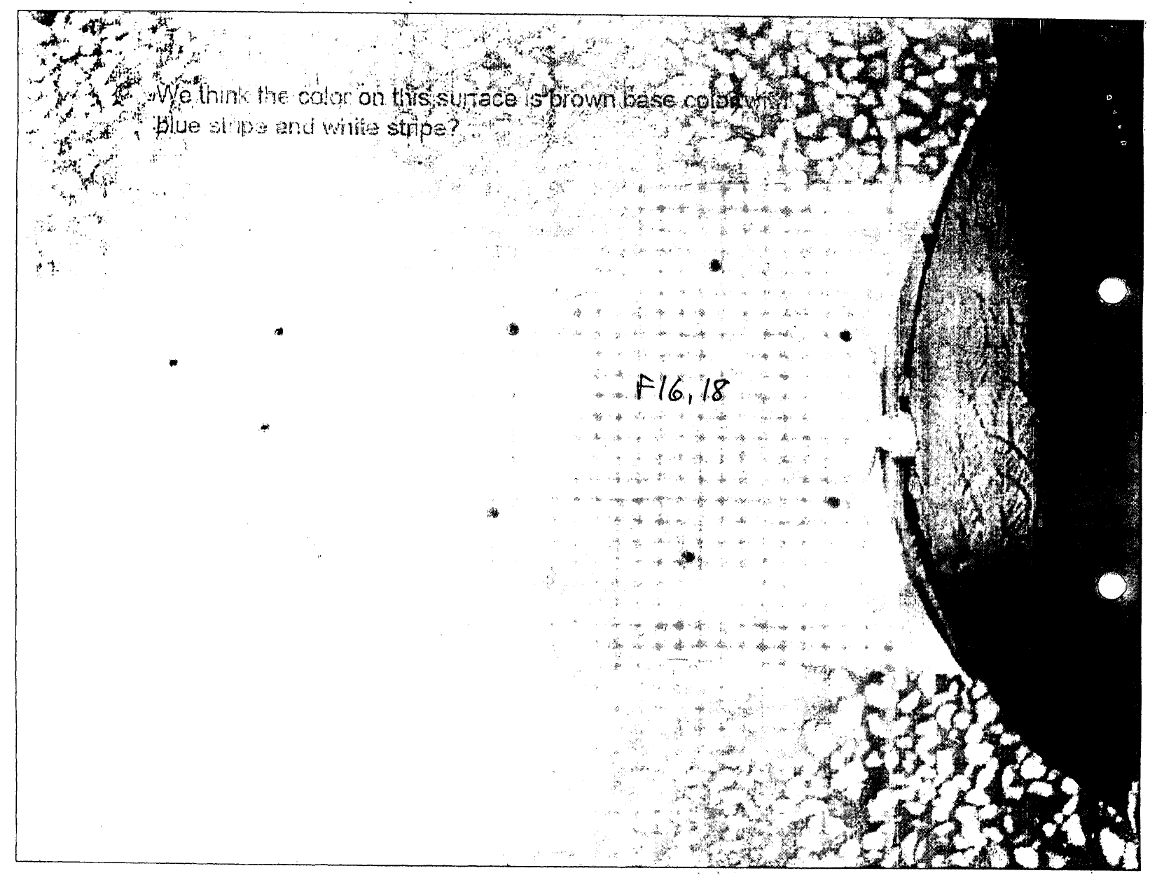

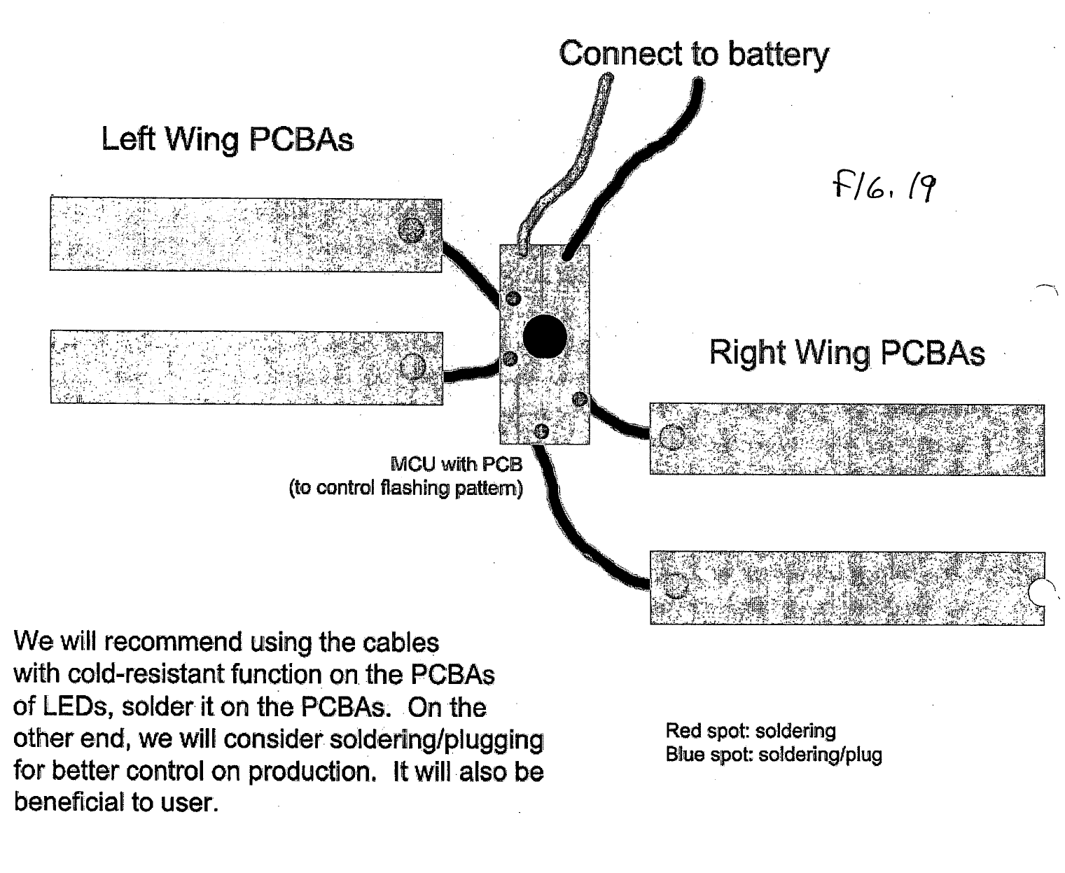

FIGS. 1-19 illustrate embodiments or the decoy of the present invention, assemblies or parts thereof, and methods thereof.

The apparatus of the invention is a decoy including a body, a stake extending from the body for connection to earth, and wings extending from the body. The wings have a first surface which has a convex or convex-like configuration. The surface may be rectilinear, curvilinear or a combination thereof. Lights, preferably LEDs, are constructed and arranged relative to the first surface such that they emit light away from the first surface and to the environment. The LEDs are selectively activated so as to simulate wing movement. A power source, such as a battery, and a control circuit are communicatively connected to the LEDs for activation.

Embodiments of the decoy apparatus of this invention are useful to hunters and birders. The apparatus may be controlled or regulated by individual state Natural Resource Departments.

Existing spinning wing decoys use a mechanical means to attract waterfowl and/or other birds. Such mechanical decoys can malfunction due to corrosion, damaged motorshafts, and the like. Additionally, several states currently ban spinning wing decoys.

The present invention utilizes LEDs mounted on wings so that they direct light away from the wings surfaces. They are energized to cause strobe effect, which simulates flapping wings

Apparatus Specifications:
1) 20 white Superbright Type “A” LED's are attached to each wing to simulate the flashing that the spinning of the wing creates.
2) 10 of the LED lights are on a plane parallel with the ground and 10 are on a plane that is 30 degrees from the first.
3) The wing color preferably matches the color of the current Lucky Duck™ Wing, manufactured and distributed by Expedite International of Hudson, Wis., USA.
4) 6V battery lead acid battery.
5) Battery charger.
6) Includes Lucky Duck decoy body.
7) Wing is shown in drawing Figures.
8) Wings must have holes that the LED's protrude through.
9) Wing is attached to the body of the decoy with a thumb screw.
10) Wing preferably does not include foldable joint.
11) Includes Lucky Duck stake.
12) 3 position switch.
13) Wire harness to accommodate Lucky Duck remote control.

The descriptions above and the accompanying materials should be interpreted in the illustrative and not the limited sense. While the invention has been disclosed in connection with the preferred embodiment or embodiments thereof, it should be understood that there may be other embodiments which fall within the scope of the invention.

The invention claimed is:

1. A decoy including a body; a stake extending from the body for connection to earth; wings extending from the body, the wings have a first surface which has a convex or convex-like configuration; lights are constructed and arranged relative to the first surface such that they emit light away from the first surface and to the environment; and means to selectively activate the lights so as to simulate wing movement.
